(19) United States
(12) Patent Application Publication
(10) Pub. No.: US 2011/0013559 A1
(43) Pub. Date: Jan. 20, 2011

(54) WIRELESS COMMUNICATION VIA A TUNNEL THROUGH A SERVING ACCESS NETWORK

(75) Inventor: James S. Marin, Murphy, TX (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/825,557

(22) Filed: Jun. 29, 2010

Related U.S. Application Data
(60) Provisional application No. 61/225,941, filed on Jul. 16, 2009.

(51) Int. Cl. H04W 40/00

(52) U.S. Cl. 370/328

(57) ABSTRACT

Disclosed are an apparatus and a method for wireless communication with a non-serving access network via a tunnel through a serving access network. The method includes establishing a tunnel through a serving network to a target network independent of a handoff. The method then provides for communicating via the tunnel between a mobile station and the target network.

### CROSS-REFERENCE TO RELATED APPLICATIONS

The present application claims priority to U.S. Provisional Patent Application 61/225,941, filed on Jul. 16, 2009.

### FIELD OF THE INVENTION

The present invention relates generally to wireless radio communication and, in particular, to wireless communication via a tunnel through a serving access network.

### BACKGROUND OF THE INVENTION

With the proliferation of different and newer available network access technologies, mobile radiotelephone stations (i.e., cell phones) now have the ability to support more than one access technology. However, unless these mobile stations have multiple transceiver systems that are capable of parallel operation, the mobile station (MS), also known as an Access Terminal (AT) or User Equipment, is only able to communicate on one network access technology at a time. In addition, a cellular service operator may support legacy services on an old core network and may not want to re-implement the old services to a new network. Further, a cellular operator may choose to discourage or otherwise disallow some services, such as Voice over Internet Protocol services, which may be readily available via an alternative access technology supported by the MS.

It is known, in 3GPP Universal Mobile Telecommunications System (UMTS) wireless communication networks, WiMAX networks, and Long Term Evolution (LTE) and 4G wireless telecommunication networks that include Evolved UMTS Terrestrial Radio Access Network (E-UTRAN) and High Rate Packet Data (HRPD) networks (also known as 1×-EV-DO or DO), that a tunnel can be connected between an MS and a non-serving base station through a serving base station. For example, a tunnel can be used to provide a signal forwarding function, an architecture for pre-establishing a target session prior to handoff, and a signal adaptation protocol. For example, it is known to pre-establish a session on a target network using a tunnel through a source network. When a handoff decision is made, the session is quickly transferred to the target technology using signaling through the tunnel and without being slowed by the session establishment time. However, it has not been known how a tunnel could be defined to also be used for paging or data exchange, whether or not a handoff is desired. It is also known for a MS to receive broadcast information from target base stations via a layer 3 tunnel through a source network, which helps the MS identify neighboring candidate target base stations. However, it has not been known how paging can be enhanced through the tunnel.

Various base-station products have been designed to support LTE-DO interworking while retaining a legacy Packet Data Serving Node (PDSN) A10/A11 connection. Specifically the eAN will have an A10/A11 connection to a PDSN as well as a new HSGW connection which connects the 3GPP Evolved Packet Core (EPC). However, if HRPD packet data arrives for a dormant legacy packet data session while the AT is tuned to the LTE network, then there is currently no method defined to notify (i.e., page) the AT via the HRPD air interface.

3GPP2 C.S0087-0 (v1.0, E-UTRAN-cdma2000 Connectivity and Interworking: Air Interface Specification, May 2009) defines a signaling adaptation protocol that enables transport of messages of non-serving technology (e.g., HRPD air interface messages) via a tunnel through a serving access technology (e.g., E-UTRAN). C.S0087 also defines an AlternativeLinkPageReq message that supports paging via the tunnel. However, C.S0087 does not describe the access network behavior needed to implement the AlternateLinkPageReq message.

3GPP2 C.S0024-A (v3.0, “cdma2000 High Rate Packet Data Air Interface Specification”, September 2006) defines signaling messages necessary to establish an HRPD connection and HRPD session. 3GPP2 A.S0008-C (v1.0, “Interoperability Specification (IOS) for High Rate Packet Data (HRPD) Radio Access Network Interfaces with Session Control in the Access Network,” July 2007) and 3GPP2 A.S0009-C (v1.0, “Interoperability Specification (IOS) for High Rate Packet Data (HRPD) Radio Access Network Interfaces with Session Control in the Packet Control Function,” July 2007) define access network behavior for establishing an HRPD connection, an HRPD Session, and a CDMA packet data session. However, none of these specifications define how, given that HRPD is considered as the non-serving technology, to use a tunnel through a serving technology to support an HRPD packet data session.

The layer 3, i.e., generally routable, tunnel method of assisting handoff is currently described in George Lampropoulos, Apostolic Salkintzis, and Niko Passas, “Media-Independent handover for Seamless Service Provision in Heterogeneous Networks,” IEEE Communication Magazine, Vol. 46 No 1, January 2008, and is also specified in 3GPP2 standards X.S0058-0 (v1.0, “WiMAX-HRPD Interworking: Core Network Aspects,” January 2009), A.S0023-0 (v1.0, “Interoperability Specification (IOS) for High Rate Packet Data (HRPD) Radio Access Network Interfaces and Interworking with World Interoperability for Microwave Access (WiMAX),” April 2009), and C.S0086-0 (v1.0, WiMAX™-HRPD Interworking: Air Interface Specification, May 2009). While paging and specifically various methods of cross technology paging are known, there is no art that discloses using a tunnel (between a mobile and target base station through a serving access technology) to do cross technology paging.

U.S. Pat. No. 7,373,146 provides a method of cross-paging (paging a mobile via a 1× access network when data arrives from a packet network). The method relates to cross-paging methods standardized for hybrid 1× and HRPD systems (see C.S0075-0, “Interworking Specification for cdma2000 1× and High Rate Packet Data System,” March 2006). This reference describes a Layer 2, i.e., a dedicated application specific, interface between the HPRD AN and the 1× Base station for sending cross-paging requests and responses but does not describe a method of paging or show how Internet Protocol (IP) addresses and domain names are assigned to enable paging via a tunnel through another access network.

U.S. Pat. No. 6,961,578 describes paging through a tunnel between the 3GPP SGSN and the mobile when an incoming circuit switched call arrives. This reference describes two concepts. The first concept is a method of establishing a circuit call to a mobile that is “camped” on a packet air interface and is not monitoring the circuit air interface. The method claims to eliminate the two to five second delay of paging the mobile by estimating mobile location. The second concept defines a new network entity, “location services node,” that receives location requests and stores location information. This reference does not relate to paging. While this reference describes a layer 3 tunnel through an access network that initially connects the mobile with the network, the tunnel is not being used to pre-establish a connection with a target network prior to handoff, nor is the tunnel used for paging or data exchange.

US 2003/0143999 deals with dynamic paging area construction methods and apparatus. However, this reference does not describe cross-paging between access technologies.

3GPP2 C.S0087-0 (v1.0, E-UTRAN-cdma2000 Connectivity and Interworking: Air Interface Specification, May 2009) defines MS requirements to support a Layer 2 tunnel for optimized handoff method between E-UTRAN and HRPD access networks. This reference supports cross paging and defines an AlternateLinkPageReq message that allows an MS to receive a page indirectly from a target technology via a tunnel through a modified serving technology. Thus, the E-UTRAN and HRPD system has defined new messages in addition to the HRPD air interface page message. However, the delivery of the page AlternateLinkPageReq message in an E-UTRAN-HRPD system where E-UTRAN is the serving technology requires a modified MME and eNB per 3GPP TS 36.413 (v8.4.0, “Evolved Universal Terrestrial Radio Access Network, S1 Application Protocol (S1AP) Release 8,” 2008-12) Section 8.8 and other 3GPP specifications. However, at this time the network behavior (per X.S0057-0, v1.0, “E-UTRAN-eHRPD Connectivity and Interworking: Core Network Aspects,” April 2009, and A.S0022-0, v1.0, “Interoperability Specification (IOS) for Evolved High Rate Packet Data (eHRPD) Radio Access Network Interfaces and Interworking with Enhanced Universal Terrestrial Radio Access Network (E-UTRAN),” March 2009) to use the AlternateLinkPageReg message is unknown.

Therefore, it would be beneficial to provide a technique for a mobile station to be able to receive and send data via an access technology that is different that the access technology on which the mobile station is currently being served. In particular, a technique is needed to support paging and data exchange in situations where the air interface connection of the target network (non-serving access technology) is not available, but a connection via another access technology is available.

### BRIEF SUMMARY

The above considerations, and others, are addressed by the present invention, which can be understood by referring to the specification, drawings, and claims. According to aspects of the present invention, a method for wireless communication with a non-serving access network via a tunnel through a serving access network includes a step of establishing a tunnel through a serving network to a target network independent of a handoff. A next step includes communicating via the tunnel between a mobile station and the target network.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an example of a mobile station being serviced by two access networks, in accordance with the present invention;

FIG. 2 is a flow chart of signaling to an MS in accordance with the present invention;

FIG. 3 is a flow chart of signaling from the MS in accordance with the present invention;

FIG. 4 is an example of an LTE embodiment of the present invention;

FIG. 5 is a flow chart of signaling in accordance with a first embodiment of the present invention;

FIG. 6 is a flow chart of signaling in accordance with a second embodiment of the present invention;

FIG. 7 is a flow chart of signaling in accordance with a third embodiment of the present invention;

FIG. 8 is a flow chart of signaling in accordance with a fourth embodiment of the present invention;

FIG. 9 is a flow chart of signaling in accordance with a fifth embodiment of the present invention; and

FIG. 10 illustrates a method in accordance with the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

The present invention provides a technique for a mobile station to be able to receive and send data via an access technology that is different from the access technology on which the mobile station is currently being served. In particular, a technique is provided to support paging and data exchange in situations where the air interface connection of the target network (non-serving access technology) is not available, but a connection via another access technology is available.

In practice, the present invention applies to systems with multiple access technologies (e.g., LTE-DO, LTE-1×, WiMAX-DO, WiFi-1×, Femto-cell) and specifically to a Layer 3 tunnel method, such as used for WiMAX-DO interworking or a Layer 2 tunnel method such as LTE-DO interworking. Further, the present invention can also establish the tunnel whether or not a handoff is desired. In this way, the tunnel usage is extended to paging and data delivery even if the tunnel is not used for handoff. In particular, the present invention describes core network aspects of paging and data exchange using a tunnel for communication with a single transmitter mobile.

The present invention also enhances paging replies from a single transmitter and dual receiver mobile in that the paging reply can be sent through the serving network even though the paging request came from a target network, thus avoiding the need to handoff prior to responding to a page.

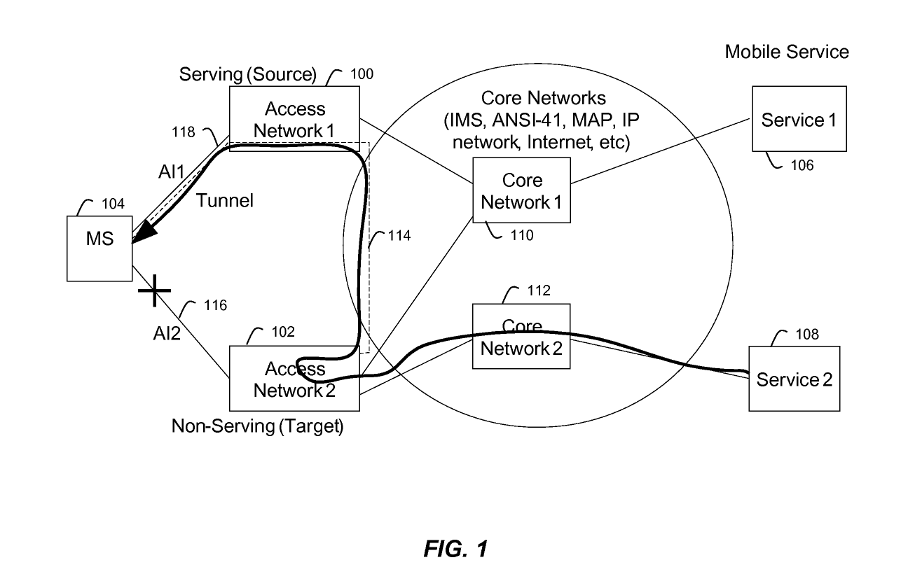

FIG. 1 illustrates a cellular communication network having multiple heterogeneous access networks that provide services to a mobile station 104. Mobile services 106, 108, shown as Service 1 (S1) and Service 2 (S2), may be, for example, voice telephony, text messaging, Internet access, or other services commonly available to subscribers. The services 106, 108 connect to the MS 104 via core networks 110, 112 and access networks 100, 102. In the example shown S1 106 uses a Type 1 Core Network 1 (CN1), and S2 108 uses a Type 2 Core Network 112 (CN2). The Type 1 Access Network 100 (AN1) communicates with the MS 104 via Air Interface 1 (AI1) 118, and the Type 2 Access Network 102 (AN2) communicates with the MS 104 via Air Interface 2 (AI2) 116.

CN1 110 enables handoff in that S1 106 can be routed through either AN1 100 or AN2 102 as the MS 104 moves. To support handoff, a connection can be made to the source access network 100 for pre-establishing communications between the MS 104 and a target base station in the target access network 102. S2 108 connects to the MS 104 via CN2 112, AN2 102, and AI2 116. However, AI2 116 may be unavailable (as shown) for several reasons such as the MS 104 is tuned to AI1 118 and cannot monitor AI2 116 or the radio link quality of AI2 116 is poor. If S2 108 were to request service, then the service request would fail when AN2 102 tried to contact the MS 104 via AI2 116. If, however, a tunnel 114 was available through AN1 100, then the service request can be re-routed via the tunnel 114 through AN1 100, as described below for the present invention.

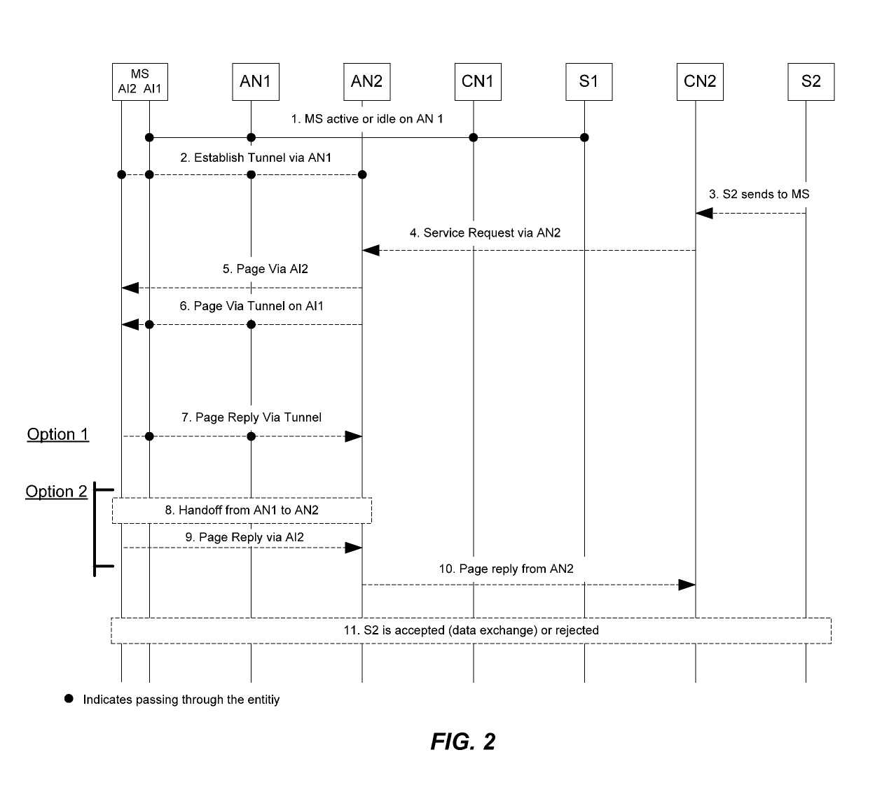

FIG. 2 illustrates a message flow in which paging information delivered to the AN2 102 is re-routed to the MS 104 via the tunnel 114. As a pre-condition, it is assumed that a packet data session is dormant on target access technology 102. The dormant session means that the CN2 has a record of the probable location of the MS if data should arrive for delivery to the mobile.

In operation, in step 1 the MS is active or idle on AN1. A dormant packet data session may exist on AN2. However, even if a dormant session did not exist, AN2 may deliver global pages to try and locate the MS.

In step 2, the MS establishes a tunnel via AN1. The tunnel is an MS-to-AN2 upper-layer connection using a common IP traffic data connection via an MS tuned to AI1 and connected to the AN2 upper layers. An example of Layer 3 tunnel establishment is specified in 3GPP2 X.S0058. For example, in accordance with the present invention, the tunnel could be established when the MS powers up, by user command on the MS, in preparation for handoff, by a rendezvous protocol that allows an MS to establish a link with a base station or when AI2 coverage is detected. AN1 procedures can be modified to support paging and data exchange via a tunnel through a serving access technology.

In step 3, S2 sends a message destined for the MS based on the routing information for the dormant packet data session or based on a global paging algorithm. The message may be, for example, a voice call origination, a Short Message Service (SMS) text message, an Internet message such as a software update alert, or other notification. The request arrives at CN2 which is the core network associated with S2.

In step 4, CN2 notifies AN2 of the incoming service request based on the routing information of the dormant session. It should be noted that if S2 were to use CN1 instead of CN2, then there is little need to page via a tunnel; however, it is not practical to assume that all services can run through a common core network. There are many scenarios in which S1 and S2 do not share a common core network. For example, a legacy network such as a circuit switched network might support SMS delivery, and the network might use paging to deliver SMS messages, but the operator has not connected or does not plan to connect the legacy SMS system to a new network such as LTE/EPC. In addition, a mobile may roam into another operator's network in which operators intentionally offer different services; however, a subscriber would like to have his home services available while roaming to a visited network.

In step 5, AN2 may page the MS via AI2. If AN2 knows that the MS is unlikely to respond to a page and an alternative method of paging is available, AN2 may skip this step.

In step 6, AN2 may page the MS via the tunnel, in accordance with the present invention.

The paging reply has several scenarios depending on the configuration of the MS and on the nature of the AN1 connection (Step 1). If, for example:
a. The MS has a single transmitter, single receiver, and is active on an AN1 call. In this case, the MS would not be able to receive the step 5 page via AI2 and could only receive the page via the tunnel (step 6). S1 might be handed off to AN2.
b. The MS has a single transmitter, a single receiver, and is idle on an AN1 call. In this case, the MS would not be able to receive the step 5 page via AI2, but the MS could receive the page via the tunnel (step 6). S1 might be handed off to AN2.
c. The MS has a single transmitter, a dual receiver, and is active on an AN1 call. In this case, the MS could receive the step 5 page via AI2. The MS could reply to the page via the tunnel or, in some cases, S1 might be handed off to AN2 and then reply to the page via AN2. However, performing a handoff of an active S1 risks degrading or possibly dropping S1. If, for example, S2 was a simple SMS delivery service, then a short SMS delivery acknowledgement via the tunnel is considered better than the risk to S1 in a handoff.
d. The MS has a single transmitter, a dual receiver, and is idle on an AN1 call. In this case, the MS could receive the step 5 page via AI2. The MS could reply to the page via the tunnel or, in some cases, S1 might be handed off to AN2 and then reply to the page via AN2. While performing a idle handoff of S1 would not degrade S1, if, for example, S2 was a simple SMS delivery service, then a short SMS delivery acknowledgement via the tunnel is probably more desirable than handing off S1. For example, an operator may have provisioned the MS to prefer AN1, and the MS attempts to stay on AN1 most of the time.
e. The MS has a dual transmitter, single receiver, and is active on an AN1 call. In this case, the MS would not be able to receive the step 5 page via AI2 but could reply to the page via AI1 or AI2. However, dual transmitter and single receiver mobiles are not expected to be implemented.
f. The MS has a dual transmitter, single receiver, and is idle on an AN1 call. In this case, the MS would not be able to receive the step 5 page via AI2 but could reply to the page via AI1 or AI2. However, dual transmitter and single receiver mobiles are not expected to be implemented.
g. The MS has a dual transmitter, a dual receiver, and is active on an AN1 call. In this case, the MS could receive the step 5 page via AI2 and the step 6 page via the tunnel. Having two methods of delivering a page increases the probability that one of the pages is successful. If the page is, for example, an SMS message, the page reply could be via the tunnel, and it would be unnecessary to perform handoff which could fail or otherwise degrade S1.
h. The MS has a dual transmitter, a dual receiver, and is idle on an AN1 call. In this case, the MS could receive the step 5 page via AI2 and the step 6 page via the tunnel. Having two methods of delivering a page increases the probability that one of the pages is successful. If the page is, for example, an SMS message, the page reply could be via the tunnel, and it would be unnecessary to perform handoff which could fail or otherwise degrade S1. If S2 is a notification of an incoming call, the MS could perform idle handoff to AN2.

Whether or not the MS receives the page via step 5 or step 6, the MS may reply by either the tunnel (Option 1) of the present invention, or the MS may perform handoff and reply via AI2 (Option 2). A page reply may be of several types such as a page reply message or a transition to a connection setup procedure.

In step 7, for Option 1 of the present invention, the MS replies to the page via the tunnel. Option 1 allows a page reply without requiring the MS to tune to AI2. Tuning to AI1 may not be possible due to a low signal connection on AI2 or without adversely impacting S1.

In step 8, for Option 2, the MS is handed off to AN2.

In step 9, for Option 2, the MS replies to the page via AI2. The page reply may have been initiated by the page request via the tunnel over AI1 (step 6), but the reply comes via a different technology, AI2.

In step 10, AN2 replies to the page.

In step 11, S2 is accepted or rejected depending on information in the page reply (Step 10). If for example, S2 is a voice call origination then several messages flow back and forth to process the call, re-activate the dormant packet data session, and exchanged data with the MD via the tunnel. If the page is rejected, then CN2 normally notifies S2 of the rejection.

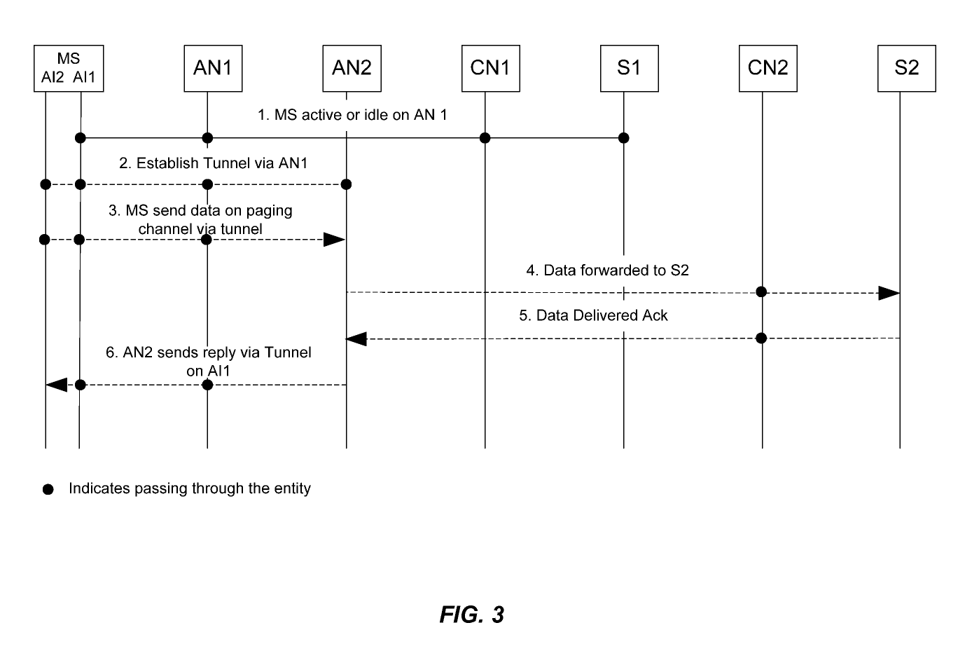

FIG. 3 illustrates a message flow in which an MS sends data via a tunnel through AN1, in accordance with the present invention.

In step 1, the MS is active or idle on AN1. A dormant packet data session exists on AN2.

In step 2, the MS establishes a Layer 3 tunnel via AN1. An example of such tunnel establishment is specified in 3GPP2 X.S0058.

In step 3, the MS sends data on a paging channel via the tunnel, in accordance with the present invention.

In step 4, AN2 forwards the data to CN2 which in turn sends the data to S2. As a use-case, data may be SMS data, and S2 may be the message center associated with SMS.

In step 5, if the date delivery is acknowledged, then S2 sends a data delivered acknowledgment message to CN2 which, in turn, sends the message to AN2.

In step 6, AN2 sends a data delivered acknowledgement to the MS on a paging channel via a tunnel through AN1, in accordance with the present invention.

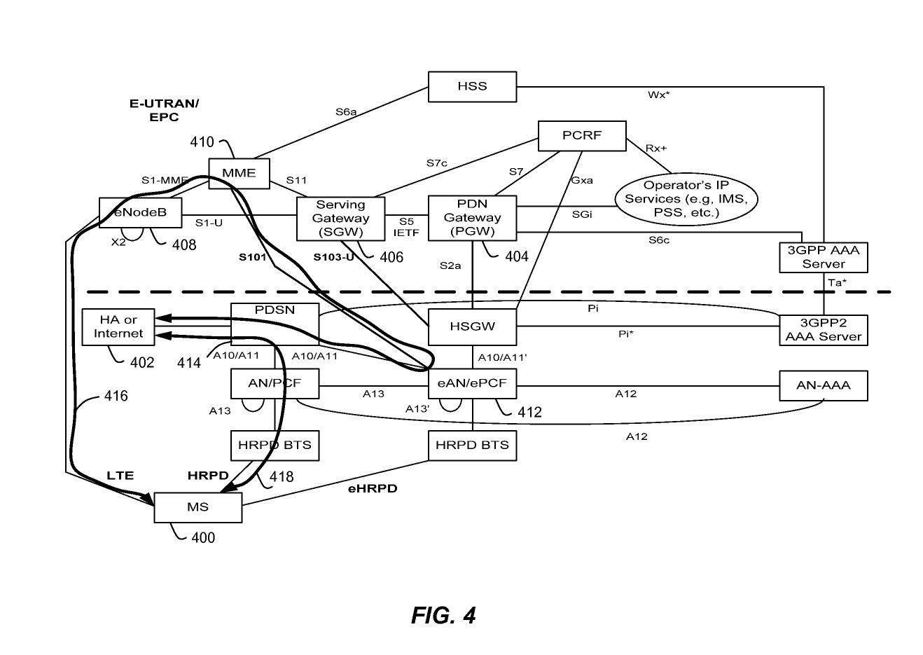

FIG. 4 shown an LTE-DO (Data Optimized) embodiment of the present invention, where an E-UTRAN and eHPRD interworking architecture provides re-routing of a legacy HRPD service request. Current network plans call for the eAN to connect to a PDSN (A10/A11) as well as an HSGW (A10/A11′). In this example, the MS could be supporting an LTE call, when the PDSN sends a service request to the eAN. Using the current standards, a page would fail because the MS (assumed to have single transmitter and single receiver) is not monitoring the eHRPD air interface.

The present invention provides a technique to notify (page) the mobile via the LTE air interface so that the DO data can be delivered, and in particular, the eAN can re-route the service request over a tunnel through the E-UTRAN. With the optimized (i.e., S101) handoff interface, the eAN re-directs a service request with data ready such that a page is issued via the S101 tunnel. An HRPD connect and session is established via the tunnel while the mobile is tuned to LTE. The tunnel is then used to deliver the data to the HRPD side of the MS even though the MS is currently tuned to the LTE physical layers.

In particular, an MS 400 is originally in HRPD with data anchored in a Home Agent (HA) 402. The MS moves to LTE service and gets another IP address via PDN Gateway 404, through the Serving Gateway (SGW) 406 and eNodeB 408. However, for the original session 418, the MS's HRPD radio connection is not retained even though the packet data session with the HA is retained. The MS 400 then pre-registers, through the eNodeB 408 and MME 410, with eAN 412 via S101. The eAN 412 updates the context/connection with the PDSN 414. When data arrives at eAN/ePCF 412 via PDSN 414, the eAN 412 sends a page message 416 via the S101 tunnel. The MS 400, on receiving the page moves over to HRPD and continues to receive data from the HA 402.

In summary, a tunnel is first established through a serving network whether or not handoff is expected. The tunnel connects an MS with non-serving access technology for reactivation of dormant packet data sessions or general pages. Pages and data can then be delivered from AN2 to the MS via the tunnel through AN1. Also, pages and data can be delivered from AN2 to the MS via both AI2 and via a tunnel trough AN1. A response to pages can then be sent from the MS to AN2 via a tunnel trough AN1. Also, a response to pages can be delivered from the MS to AN2 via a tunnel through AN1 after performing handoff from AN1 to AN2 triggered by the page.

In one embodiment, paging and data exchange can include a base station deciding to forward a page and then transmit paging information to an MS via a tunnel through a serving access technology.

In another embodiment, a response to a page can include an MS transmitting the reply by either the tunnel or by handing off and then transmitting the reply via the air interface of the target base station.

In another embodiment, a page is forwarded to an MS by a base station deciding whether to deliver the page via an air interface or via a tunnel. The decision is based on whether a tunnel exists, whether an air interface connection is probable, whether the MS has moved outside the coverage area of the base station, or whether the base station is a virtual base station (i.e., with tunnel connections and without a radio interface).

In another embodiment, data is exchanged between an MS and a base station of a non-serving access technology via a tunnel through a serving access technology where the base station decides whether or not to route the data through the tunnel to the MS and whether to forward the data received from the MS via the tunnel to the network.

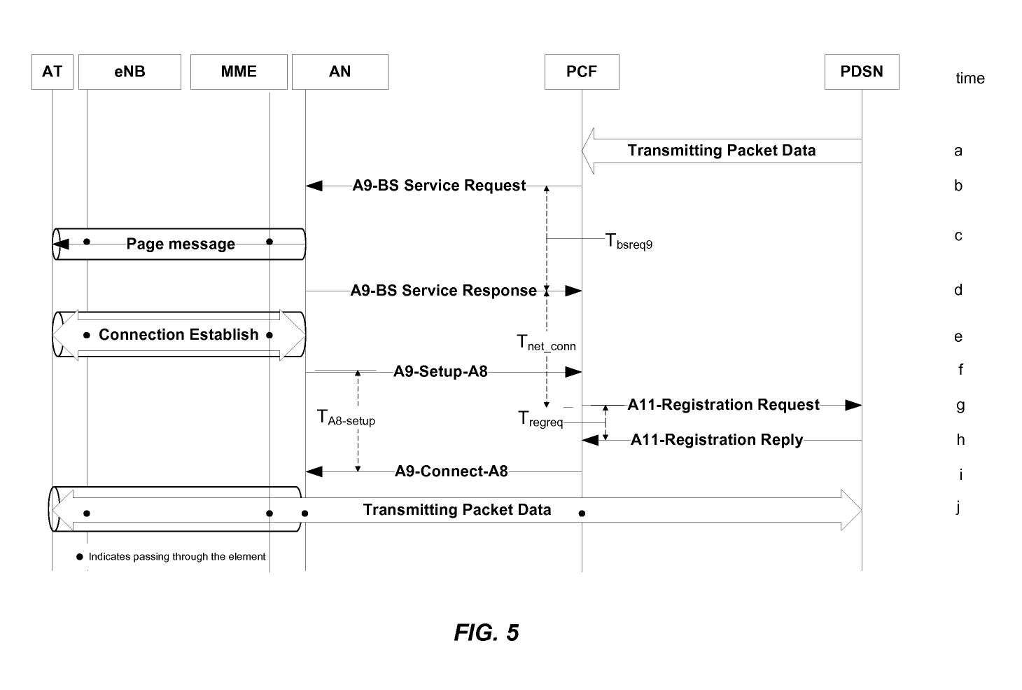

FIG. 5 provides a specific E-UTRAN embodiment of the present invention with a network initiated call re-activation from a dormant state via a tunnel through E-UTRAN. In this scenario, it is assumes that the AT (i.e., MS) has previously established an HRPD packet data session and also an HRPD session, however it does not have an HRPD connection, and there is no A8 connection between the AN and the PCF. The HPRD packet data session is dormant, and the AT is tuned to E-UTRAN. The flow assumes that a tunnel has been established between the eAT and eHRPD via the E-UTRAN (see, for example, A.S0022-0 v1.0, paragraph 3.2.1.1.1, steps 1 through 3).

In step a, the PDSN sends packet data to the PCF.

In step b, the PCF sends an A9-BS Service Request message to the AN to request packet service and starts timer Tbsreq9. The SR_ID is set to ‘1’ and is ignored by the AN, since this message is a request to set up all A8 connections needed for the IP flow mapping maintained by the AN.

In step c, the AN responds with an A9-BS Service Response. The PCF stops timer Tbsreq9 upon receipt of the A9-BS Service Response message and starts timer Tnet_conn.

In step d, the AN sends a Page message to the AT via a tunnel through the eNB and the MME (see C.S0087-0 for processing of messages via the tunnel), in accordance with the present invention.

In step e, the AT initiates connection establishment procedures with the AN via a tunnel through the eNB and MME, in accordance with the present invention.

In step f, the AN sends an A9-Setup-A8 message to the PCF with Data Ready Indicator set to ‘1’ to establish the A8 connections and starts timer TA8-setup. When the PCF receives the A9-Setup-A8 message, it stops timer Tnet_conn.

In step g, the PCF sends an A11-Registration Request message to the PDSN with accounting information and starts timer Tregreq.

In step h, the PDSN responds with an A11-Registration Reply message. The PCF stops timer Tregreq.

In step i, the PCF sends the A9-Connect-A8 message to the AN. When the AN receives the A9-Connect-A8 message, it stops timer TA8-setup.

At step j the connection is established, and packet data can flow between the AT and the PDSN via a tunnel through the E-UTRAN, in accordance with the present invention.

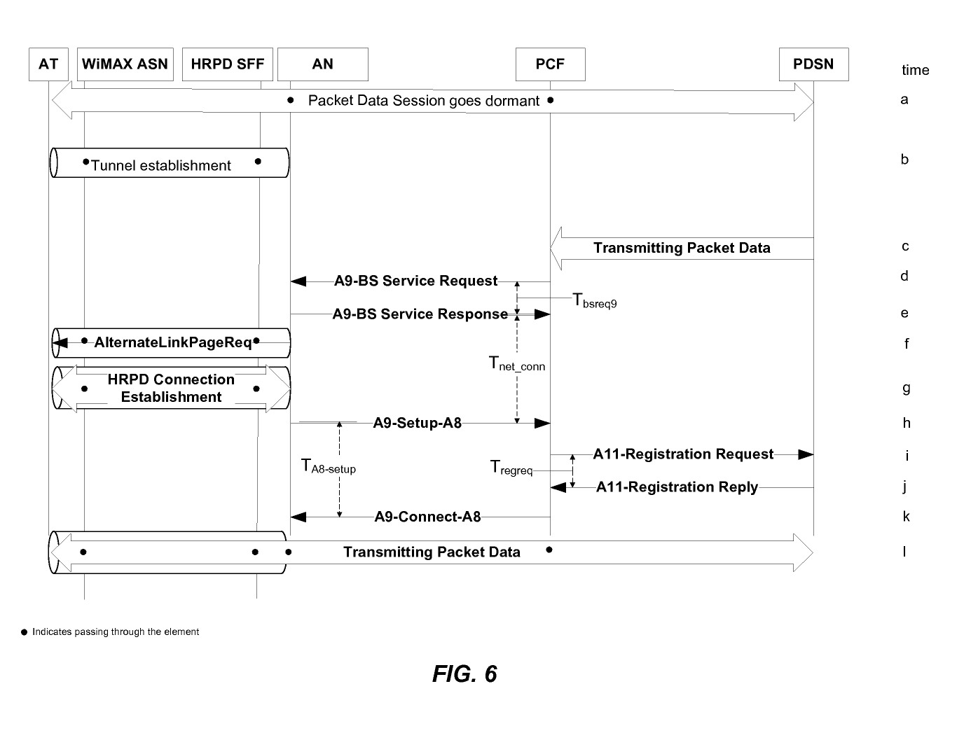

FIG. 6 provides a specific WiMAX embodiment of the present invention that allows pages and data exchange that would otherwise be delivered over the HRPD air interface to instead be delivered via a layer 3 tunnel. This feature allows the MS/AT to remain tuned to the WiMAX network while simultaneously exchanging HRPD page and data messages. Alternatively, the page message may trigger a handoff from WiMAX to HRPD before delivery of data messages. In particular, FIG. 6 shows a network initiated call re-activation from a dormant state via a tunnel through a WiMAX network.

In step a, while operating on the HRPD air interface, the packet data session go to a dormant state, and the AT switches from the HRPD air interface to the WiMAX air interface. The last known location of the AT in HRPD mode is via the HRPD AN, and the core network servicing the AT in HRPD mode is assumed to know the location of the AT.

In step b, using conventional Internet service via the WiMAX air interface, the AT establishes a tunnel to the HRPD AN that provided the packet data session in step a, in accordance with the present invention. Note, that the HPRD AN that last provided service may not be the HRPD AN that could provide service in a handoff situation.

In step c, the PDSN sends packet data to the PCF.

In step d, the PCF sends an A9-BS Service Request message to the AN to request packet service and starts timer Tbsreq9. The SR_ID is set to ‘1’ and is ignored by the AN, since this message is a request to set up all A8 connections needed for the IP flow mapping maintained by the AN.

In step e, the AN responds with an A9-BS Service Response. The PCF stops timer Tbsreq9 upon receipt of the A9-BS Service Response message and starts timer Tnet_conn.

In step f, knowing that a tunnel is available and that an HRPD connection is not available, instead of sending a Page message over the air, the AN sends an AlternateLinkPageReq message via a tunnel through the HRPD SFF and the WiMAX ASN (see C.S0086-A for processing of message via the tunnel), in accordance with the present invention.

In step g, the AT initiates connection establishment procedures with the AN via a tunnel through the HRPD SFF and the WiMAX ASN, in accordance with the present invention.

In step h, the AN sends an A9-Setup-A8 message to the PCF with Data Ready Indicator set to ‘1’ to establish the A8 connections and starts timer TA8-setup. When the PCF receives the A9-Setup-A8 message, it stops timer Tnet_conn.

In step i, the PCF sends an A11-Registration Request message to the PDSN with accounting information and starts timer Tregreq.

In step j, the PDSN responds with an A11-Registration Reply message. The PCF stops timer Tregreq.

In step k, the PCF sends the A9-Connect-A8 message to the AN. When the AN receives the A9-Connect-A8 message, it stops timer TA8-setup.

At step 1 the connection is established, and packet data can flow between the AT and the PDSN via a tunnel through the HRPD SFF and the WiMAX ASN, in accordance with the present invention.

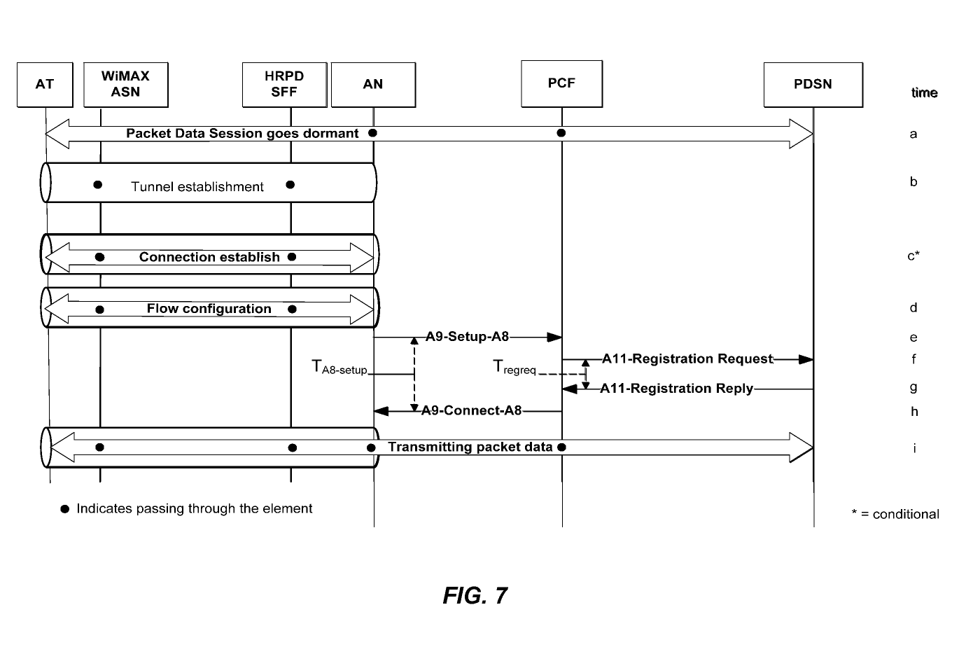

FIG. 7 shows an AT initiated call re-activation from the dormant state (Existing HRPD Session) via a tunnel through the WiMAX ASN, in accordance with the present invention. This scenario describes the data origination from a dormant AT, i.e., the AT has already established a packet data session. The AT has also established an HRPD session. The call flow assumes that a layer 3 tunnel between the AT and AN has previously been established such that the AT and AN may send HRPD messages through a tunnel that would otherwise go over the HRPD air interface. The tunnel is through the HRPD SFF and the WiMAX ASN.

In step a, while operating on the HRPD air interface, the packet data session goes to a dormant state, and the AT switches from the HRPD air interface to the WiMAX air interface. The last known location of the AT in HRPD mode is via the HRPD AN, and the core network servicing the AT is assumed to know the location of the AT.

In step b, using conventional Internet service via the WiMAX air interface, the AT establishes a tunnel to the HRPD AN that provided the packet data session in step a, in accordance with the present invention.

In step c, if the AT has data to send, the AT initiates connection establishment procedures with the AN via a tunnel through the HRPD SFF and the WiMAX ASN, in accordance with the present invention.

In step d, if the connection establishment includes an HRPD Emergency Indicator (e.g., ReservationOnRequest message includes the HRPD Emergency Indicator), the AT and AN also perform flow configuration for emergency services via a tunnel through the HRPD SFF and the WiMAX ASN and provide the ‘Emergency Services’ indicator to the PDSN via the A9 and A11 messaging. Note however, that the physical location of the AT may have moved outside of the HRPD air interface coverage provided by the last AN providing a connection prior to the connection going dormant. The location of the mobile for emergency reporting purposes may have to be flagged as being unknown or at least suspect.

In step e, the AN sends an A9-Setup-A8 message to the PCF with DRI set to ‘1’ to establish all A8 connections needed for the IP flow mapping maintained by the AN and starts timer TA8-setup.

In step f, the PCF sends an A11-Registration Request message to the PDSN with accounting information and starts timer Tregreq.

In step g, the PDSN responds with an A11-Registration Reply message. The PCF stops timer Tregreq.

In step h, the PCF sends the A9-Connect-A8 message to the AN. When the AN receives the A9-Connect-A8 message, it stops timer TA8-setup.

At step i the connection is established, and packet data can flow between the AT and the PDSN via a tunnel through the HRPD SFF and the WiMAX ASN, in accordance with the present invention.

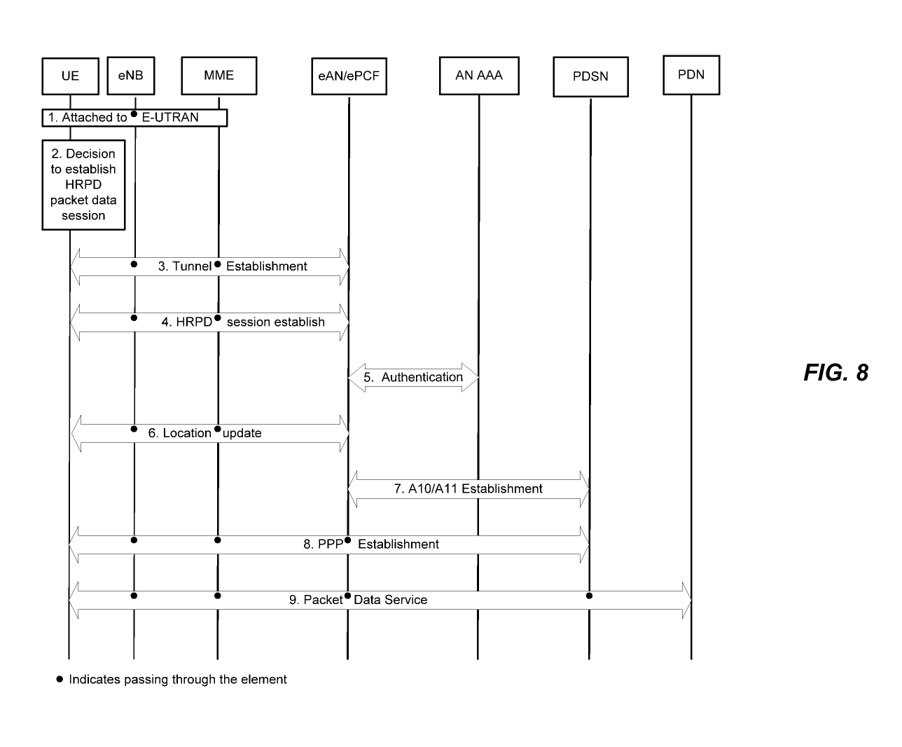

FIG. 8 shows an E-UTRAN-eHRPD Interworking embodiment of the present invention that introduces a Tunneled/Connected State, wherein a tunnel exists between the UE and the eAN via the S101 interface and through the E-UTRAN over which data may be sent. An e-UTRAN channel may exist, but no physical HRPD traffic channel exists. A connection exists between the eAN and the ePCF and between the ePCF and the PDSN, and there is a PPP link between the UE and the PDSN. This architecture supports legacy HRPD applications (see X.S0011) that do not connect through the EPC, i.e., the core network associated with the serving access network.

In step 1, the UE is attached to the E-UTRAN network.

In step 2, the UE decides to establish a packet data session with a packet data node (PDN) accessible via the HRPD access network. In the present invention, the desired packet data session uses a tunnel through, in this case, e-UTRAN instead of over the HRPD air interface, as in the prior art. Also, the prior art established a tunnel for the purpose of handoff; whereas the present invention established the tunnel as a default practice, independent of handoff considerations. The tunnel can be used for handoff, paging, data exchange, and general bearer traffic.

In step 3, the UE establishes a tunnel to the eAN/PCF via the e-UTRAN, MME and S101 interface. This is accomplished through HRPD Radio Session Establishment Signaling (see TS 23.402, section 9.3.1, step 3, for details), which includes the UL/DL information transfer, Uplink/Downlink S1 cdma2000 Tunneling, and Direct Transfer Request messages. The UE generates an UL Information Transfer message (UL HRPD message). The UL HRPD message is transferred from the UE to the eNB as a parameter in the UL Information Transfer. The eNB sends Uplink S1 CDMA2000 Tunneling message (UL HRPD message, Sector ID) to the MME. The SectorID is statically configured in the eNB. The MME selects an HRPD access node address. In order to be able to distinguish S101 signaling transactions belonging to different UEs, an S101 Session ID is used to identify signaling related to that UE on S101. The MME sends a Direct Transfer Request message (S101 Session ID, SectorID, UL HRPD message) to the HRPD access node. The MME determines the correct HRPD access node entity and address from the SectorID. (It should be noted that there is an unambiguous mapping from the SectorID to the HRPD access node address.) The HRPD Access Network sends signaling in the DL direction to the MME using Direct Transfer Request message (S101 Session ID, DL HRPD message). The S101 Session ID is used to associate the signaling with a particular UE. The MME sends the information on to the eNB using the Downlink S1 CDMA2000 Tunneling message (DL HRPD message). The eNB uses the DL information transfer message (DL HRPD message) to transport the signaling to the UE.

In step 4, after an S101 connection (i.e., tunnel) is established and to establish an HRPD connection via the tunnel, the UE sends an AlternateLinkOpenReq message [C.S0087, Figure A-1] to the eAN to request an HRPD connection. The eAN sends a AlernateLinkOpenConf message to confirm the HRPD connection at the eAN. The UE send an AlternateLinkOpenComplete message to the eAN to confirm a HRPD connection at the UE. To establish an HRPD session, the UE sends a Configuration Request message to the eAN. The Configuration Request message contains several attribute records as specified in C.S0024-A v3.0, section 14.3. The eAN sends a ConfigurationResponse message to confirm the session. Additional ConfigurationRequest and ConfigurationResponse message pairs may be exchanged. The UE sends a ConfigurationComplete message to conclude the session configuration process.

In step 5, the eAN authenticates the mobile by communicating with the AN-AAA. This scenario assumes that the authentication is successful.

In step 6, the UE may provide a location update and also assigns a new UATI.

In step 7, the eAN establishes an A10/A11 connection.

In step 8, the UE establishes a PPP connection with the PDSN.

In step 9, the UE exchanges data with a packet data service.

An active packet data session transitions to a dormant state based on closure of the HRPD radio connection. The AN or the AT can send an AlternateLinkCloseReq message to initiate closure of the HRPD connection. The AN or the AT can confirm the connection closure by sending an AlternateLinkCloseConf message. When new data arrives from the HRPD network for delivery to the AT, a dormant session is reactivated. Alternatively, if the AT has data to send, a domain session is reactivated. A dormant session is re-activated by re-establishing an HRPD connect. One technique for re-establishing an HRPD connection is for the AN to send an AlternateLinkPageReq message to the AT. Another technique is for the AT to simply send an AlternateLinkOpenReq message to the AN.

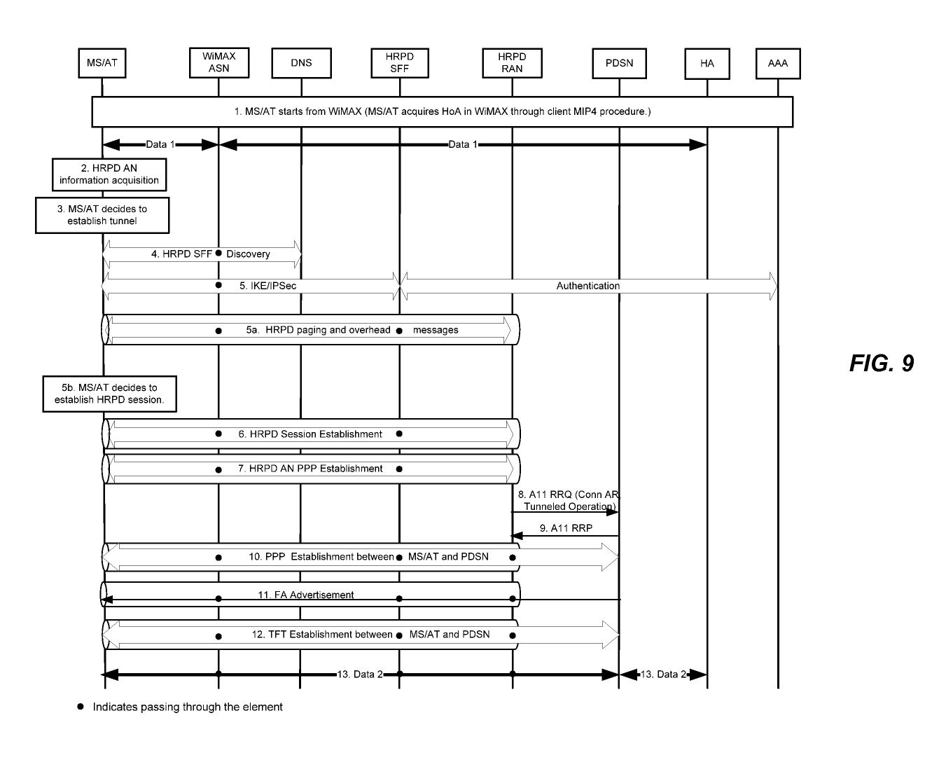

FIG. 9 shows HRPD Paging via the layer 3 tunnel. This feature allows pages that would otherwise be delivered over the air to instead be delivered via the layer 3 tunnel. This feature allows the MS/AT to remain tuned to the WiMAX network while simultaneously receiving an HRPD page. The page may prompt a data exchange via the tunnel. Alternatively, the page message may trigger a handoff from WiMAX to HRPD, which can then proceed with the data exchange using the HRPD air interface. The page messages may be for conventional location purposes or other purposes of HRPD messages such as for data messages. To perform the active handoff from HRPD to WiMAX or to perform WiMAX paging or WiMAX data exchange while the MS/AT is tuned to the HRPD network, the MS/AT needs to discover the IP address of the WiMAX SFF. Similarly the MS/AT needs to discover the IP address of the HRPD SFF to perform the active handoff from WiMAX to HRPD or to perform HRPD paging or HPRD data exchange while the MS/AT is tuned to the WiMAX network. The MS/AT will then send and receive paging and data messages that would otherwise be sent over the HRPD air interface via the X1 tunnel.

The WiMAX ASN passes X1 messages as common IP traffic. If CMIPv4 is used in the HRPD system, the HA follows the requirements specified in X.S0011. If the PMIPv4 is used in the HRPD system, the HA follows the requirements in X.S0061. Additionally the HA follows the requirements specified in WiMAX. The LMA follows the requirements specified in X.S0061 and WiMAX when PMIPv6 is used in the HRPD and the WiMAX systems. The AAA exchanges information with the HRPD SFF sufficient to establish the X1 tunnel. The PCRF supports both the WiMAX and HRPD networks.

The HRPD AN/PCF follows the requirements of A.S0023 (A), which includes the ability to send paging and data information via the A23 interface. Upon receiving information from the PDSN that would otherwise trigger an over-the-air page to the MS/AT, the HRPD AN/PCF decides whether to send the page over the air or via the A23 and X1 tunnel. If a tunnel existed, the page is sent via the tunnel; otherwise, the page is sent over the HRPD air interface. Upon receiving paging information via the X1 and A23 tunnel, the HRPD AN/PCF processes the paging information as if it had been received over the HRPD air interface. Upon receiving data from the PDSN that would otherwise be sent over the air to the MS/AT, the HRPD AN/PCF decides whether to send the data over the air or via the A23 and X1 tunnel. If a tunnel existed, the data are sent via the tunnel, otherwise, the data are sent over the HRPD air interface. Upon receiving data from the MS/AT via the X1 and A23 tunnel, the HRPD AN/PCF processes the data as if they had been received over the HRPD air interface. Data dialog 1 is an MIP-based flow in which the HA is common to the HRPD network and the WiMAX network.

After establishing the Layer 3 tunnel, paging and overhead information can flow via the tunnel between the HRPD AN and the MS/AT while the MS/AT is operating on the WiMAX air interface. After establishing an HRPD and PPP section between the MS/AT and the HPRD AN via the Layer 3 tunnel, Data dialog 2 may flow through the Layer 3 tunnel. Data dialog 2 may connect the PDSN with the HA or may be a non-MIP application in which the PDSN connects to the data application. FIG. 9 illustrates an example call flow to show paging and data exchange via the Layer 3 tunnel, with a CMIPv4-CMIPv4-based WiMAX to HRPD handoff through HRPD RAN.

In step 1, the MS/AT communicates with the WiMAX network. The MS/AT acquires CMIPv4 HoA during Mobile IP (MIP) registration procedure. Data Dialog 1 is sent between the MS/AT and the MIP home agent through the WiMAX ASN.

In step 2, the MS/AT obtains the HRPD AN information (see C.S0086).

In step 3, the MS/AT decides to establish a tunnel between the MS/AT and an HRPD AN, in accordance with the present invention.

In step 4, the MS/AT discovers the HRPD SFF's IP address.

In step 5, the MS/AT can establish the IPsec tunnel with the HRPD SFF.

In step 5a, the HRPD AN and MS/AT exchange paging and overhead information, in accordance with the present invention.

In step 5b, the MS/AT decides to establish (re-activate) an HRPD session, in accordance with the present invention.

In step 6, the MS/AT may establish a HRPD session with the HRPD Radio Access Network (RAN) through the IP tunnel (see A.S0023).

In step 7, the MS/AT establishes a PPP session with the HRPD RAN through the IP tunnel, and the device authentication is performed (see A.S0023).

In step 8, the HRPD RAN recognizes that no A10 connection associated with the MS/AT is available and selects a Packet Data Serving Node (PDSN). The HRPD RAN sends an A11-Registration Request message to the PDSN with the tunnel mode indication.

In step 9, the A11-Registration Request message is validated, and the PDSN accepts the connection by returning an A11-Registration Reply message with an accept indication.

In step 10, the MS/AT performs PPP connection establishment procedure with the PDSN and indicates it is an MIP session (see X.S0011).

In step 11, the PDSN sends FA Advertisement to the MS/AT including FA Care-of Address.

In step 12, the MS/AT establishes the TFT with the PDSN if needed.

At step 13 the MS/AT has successfully pre-established HRPD and PPP sessions. The MS/AT and HRPD AN may also exchange data.

In step 14, if the data dialog 2 includes MIP, then data flows between the PDSN and HA.

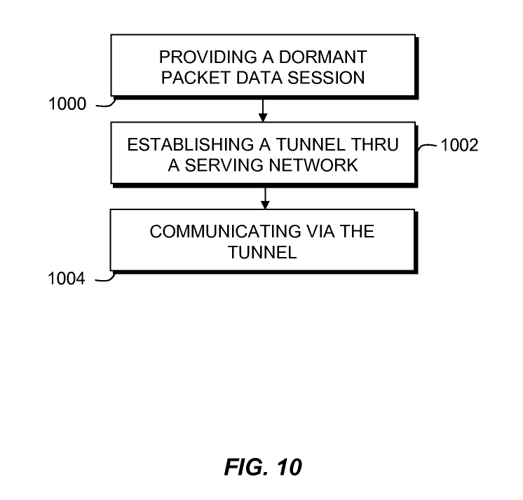

FIG. 10 is a method for wireless communication via a tunnel with a non-serving access network through a serving access network. The method includes a first step 1000 of providing a dormant packet data session on the target network.

A next step 1002 includes establishing a tunnel through a serving network to a target (non-serving) network independent of a handoff.

A next step 1004 includes communicating via the tunnel between a mobile station and the target (non-serving) network. This step can include re-activating the dormant packet data session. Communications can include paging and data exchange via the tunnel. For example, this step can include forwarding a page and transmitting paging information to a mobile station via the tunnel or an air interface of the target network. This step can also include responding to a page via the tunnel or an air interface of the target network. This step can also include handing off and then transmitting the reply to the page via an air interface of the target network.

Advantageously, the present invention increases the probability of data delivery because two (instead of one) data paths are available to reach the mobile, and because single transmitter and receiver mobile stations cannot receive or respond to a page of a non-serving technology without tuning to the non-serving technology. The present invention allows the mobile station to respond to a page of a non-serving access network without disrupting a call on the serving access network.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method for wireless communication via a tunnel with a non-serving access network through a serving access network, the method comprising:
establishing a tunnel through a serving network to a target network independent of a handoff; and
communicating via the tunnel between a mobile station and the target network.

2. The method of claim 1 further comprising:
providing a dormant packet data session on the target network;
wherein communicating comprises re-activating the dormant packet data session.

3. The method of claim 1 wherein communicating comprises forwarding a page and transmitting paging information to a mobile station via the tunnel.

4. The method of claim 1 wherein communicating comprises responding to a page via the tunnel.

5. The method of claim 1 wherein communicating comprises:
forwarding a page and transmitting paging information to a mobile station via the tunnel; and
responding to the page by handing off and then transmitting the reply via an air interface of the target network.

6. The method of claim 1 wherein communicating comprises exchanging data via the tunnel.

7. A base station in a serving access network for wireless communication via a tunnel between a mobile station and a non-serving access network, the base station comprising:
a processor configured for establishing a tunnel through the serving network to a target network independent of a handoff, the processor also configured for providing communications via the tunnel between a mobile station and the target network.

8. A mobile station configured for wirelessly communicating with a non-serving access network via a tunnel in a serving network, the mobile station comprising:
a processor configured for connecting to an established tunnel through the serving network to a target network independent of a handoff, the processor also configured for providing communications via the tunnel to the target network
